(19) United States
(12) Patent Application Publication
(10) Pub. No.: US 2026/0075622 A1
(43) Pub. Date: Mar. 12, 2026

(54) RESOURCE SCHEDULING FOR A RELAY-BASED SIDELINK NETWORK

(71) Applicant: QUALCOMM Incorporated, San Diego, CA (US)

(72) Inventors: Guangyi LIU, Shanghai (CN); Shuanshuan WU, San Diego, CA (US); Gabi SARKIS, San Diego, CA (US)

(21) Appl. No.: 18/868,137

(22) PCT Filed: Jul. 14, 2022
(86) PCT No.: PCT/CN2022/105669

§ 371 Date: Nov. 21, 2024

(51) Int. Cl. H04W 72/25; H04W 28/02

(52) U.S. Cl. CPC H04W 72/25; H04W 28/0278

(57) ABSTRACT

A method for wireless communication performed by a first relay node, includes receiving, from a donor network node, a relay network message indicating configuration information associated with a sidelink relay network. The method also includes transmitting, to one or both of the donor network node or one or more other relay nodes in the set of relay nodes, a queue report message indicating one or more channel characteristics and queue information. The method further includes receiving, from the donor network node, a resource allocation message indicating a group of resources, based at least in part on the queue report message, for communicating with the set of destination nodes. The method still further includes transmitting, to one or more destination nodes in the set of destination nodes via one or more respective sidelink channels, data via one or more resources of the group of resources.

### FIELD OF THE DISCLOSURE

The present disclosure relates generally to wireless communications, and more specifically to establishing and scheduling resources for a relay-based sidelink network.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunications standards to provide a common protocol that enables different wireless devices to communicate on a municipal, national, regional, and even global level. An example telecommunications standard is fifth generation (5G) new radio (NR). 5G NR is part of a continuous mobile broadband evolution promulgated by Third Generation Partnership Project (3GPP) to meet new requirements associated with latency, reliability, security, scalability (for example, with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the fourth generation (4G) long term evolution (LTE) standard. Narrowband (NB)-Internet of things (IoT) and enhanced machine-type communications (eMTC) are a set of enhancements to LTE for machine type communications. There exists a need for further improvements in 5G NR technology. These improvements may also be applicable to other multi-access technologies and the telecommunications standards that employ these technologies.

Some wireless communication systems may include a donor network node that communicates with one or more destination user equipment (UEs) via a relay node, such as a relay network node or a relay UE. In conventional relay networks, the relay node may communicate with the donor network node via a backhaul link and with the destination UEs via an access link. In such conventional relay networks, the relay node may receive downlink messages from the donor network node over the backhaul link and relay these downlink messages to the destination UEs over the access link. Similarly, the relay node may receive uplink messages from the destination UEs via the access link and relay these messages to the donor network node via the backhaul link. In some examples, the relay node may be used to improve spectral efficiency. Additionally, or alternatively, the relay node may be used to extend network coverage.

In some wireless communication systems, the relay node may be a sidelink device, such as a roadside unit (RSU) or a sidelink UE. In such wireless communication systems, the donor network node may communicate with the relay node via a cellular interface (for example, Uu interface) or a sidelink interface (for example, PC5 interface). Additionally, the relay node may communicate with one or more destination UEs via the sidelink interface.

### SUMMARY

In one aspect of the present disclosure, a method for wireless communication performed by a first relay node includes receiving, from a donor network node, a relay network message indicating configuration information associated with a sidelink relay network. The sidelink relay network may include a set of relay nodes and a set of destination nodes. The set of relay nodes may include the first relay node. The method further includes transmitting, to one or both of the donor network node or one or more other relay nodes in the set of relay nodes, a queue report message indicating one or more channel characteristics and queue information. The method still further includes receiving, from the donor network node, a resource allocation message indicating a group of resources, based at least in part on the queue report message, for communicating with the set of destination nodes. The method also includes transmitting, to one or more destination nodes in the set of destination nodes via one or more respective sidelink channels, data via one or more resources of the group of resources.

Another aspect of the present disclosure is directed to an apparatus including means for receiving, from a donor network node, a relay network message indicating configuration information associated with a sidelink relay network. The sidelink relay network may include a set of relay nodes and a set of destination nodes. The set of relay nodes may include the first relay node. The apparatus further includes means for transmitting, to one or both of the donor network node or one or more other relay nodes in the set of relay nodes, a queue report message indicating one or more channel characteristics and queue information. The apparatus still further includes means for receiving, from the donor network node, a resource allocation message indicating a group of resources, based at least in part on the queue report message, for communicating with the set of destination nodes. The apparatus also includes means for transmitting, to one or more destination nodes in the set of destination nodes via one or more respective sidelink channels, data via one or more resources of the group of resources.

In another aspect of the present disclosure, a non-transitory computer-readable medium with non-transitory program code recorded thereon is disclosed. The program code is executed by a processor and includes program code to receive, from a donor network node, a relay network message indicating configuration information associated with a sidelink relay network. The sidelink relay network may include a set of relay nodes and a set of destination nodes. The set of relay nodes may include the first relay node. The program code further includes program code to transmit, to one or both of the donor network node or one or more other relay nodes in the set of relay nodes, a queue report message indicating one or more channel characteristics and queue information. The program code still further includes program code to receive, from the donor network node, a resource allocation message indicating a group of resources, based at least in part on the queue report message, for communicating with the set of destination nodes. The program code also includes program code to transmit, to one or more destination nodes in the set of destination nodes via one or more respective sidelink channels, data via one or more resources of the group of resources.

Another aspect of the present disclosure is directed to an apparatus for wireless communications. The apparatus includes a processor and a memory coupled with the processor and storing instructions operable, when executed by the processor, to cause the apparatus to receive, from a donor network node, a relay network message indicating configuration information associated with a sidelink relay network. The sidelink relay network may include a set of relay nodes and a set of destination nodes. The set of relay nodes may include the first relay node. Execution of the instructions further cause the apparatus to transmit, to one or both of the donor network node or one or more other relay nodes in the set of relay nodes, a queue report message indicating one or more channel characteristics and queue information. Execution of the instructions also cause the apparatus to receive, from the donor network node, a resource allocation message indicating a group of resources, based at least in part on the queue report message, for communicating with the set of destination nodes. Execution of the instructions still further cause the apparatus to transmit, to one or more destination nodes in the set of destination nodes via one or more respective sidelink channels, data via one or more resources of the group of resources.

In one aspect of the present disclosure, a method for wireless communication performed by a donor network node includes transmitting, to a group of relay, a relay network message indicating configuration information associated with a sidelink relay network. The sidelink relay network may include a set of relay nodes of the group of relay nodes and a set of destination nodes. The method further includes receiving, from each relay node of the one or more relay nodes, a respective queue report message indicating one or more channel characteristics and queue information. The method still further includes transmitting, based on receiving the queue report messages from the set of relay nodes, a resource allocation message to the set of relay nodes that indicates a group of resources allocated among the set of relay nodes for communicating with the set of destination nodes via respective sidelink channels.

Another aspect of the present disclosure is directed to an apparatus including means for transmitting, to a group of relay nodes, a relay network message indicating configuration information associated with a sidelink relay network. The sidelink relay network may include a set of relay nodes of the group of relay nodes. The apparatus further includes means for receiving, from each relay node of the one or more relay nodes, a respective queue report message indicating one or more channel characteristics and queue information. The apparatus still further includes means for transmitting, based on receiving the queue report messages from the set of relay nodes, a resource allocation message to the set of relay nodes that indicates a group of resources allocated among the set of relay nodes for communicating with the set of destination nodes via respective sidelink channels.

In another aspect of the present disclosure, a non-transitory computer-readable medium with non-transitory program code recorded thereon is disclosed. The program code is executed by a processor and includes program code to transmit, to a group of relay nodes, a relay network message indicating configuration information associated with a sidelink relay network. The sidelink relay network may include a set of relay nodes of the group of relay nodes and a set of destination nodes. The program code further includes program code to receive, from each relay node of the one or more relay nodes, a respective queue report message indicating one or more channel characteristics and queue information. The program code still further includes program code to transmit, based on receiving the queue report messages from the set of relay nodes, a resource allocation message to the set of relay nodes that indicates a group of resources allocated among the set of relay nodes for communicating with the set of destination nodes via respective sidelink channels.

Another aspect of the present disclosure is directed to an apparatus for wireless communications. The apparatus includes a processor and a memory coupled with the processor and storing instructions operable, when executed by the processor, to cause the apparatus to transmit, to a group of relay nodes, a relay network message indicating configuration information associated with a sidelink relay network. The sidelink relay network may include a set of relay nodes of the group of relay nodes and a set of destination nodes. Execution of the instructions further cause the apparatus to receive, from each relay node of the one or more relay nodes, a respective queue report message indicating one or more channel characteristics and queue information. Execution of the instructions also cause the apparatus to transmit, based on receiving the queue report messages from the set of relay nodes, a resource allocation message to the set of relay nodes that indicates a group of resources allocated among the set of relay nodes for communicating with the set of destination nodes via respective sidelink channels.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communications system and an access network.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a diagram illustrating an example of a vehicle-to-everything (V2X) system, in accordance with various aspects of the present disclosure.

FIG. 5 is a block diagram illustrating an example of a vehicle-to-everything (V2X) system with a roadside unit (RSU), according to aspects of the present disclosure.

FIG. 6 is a graph illustrating a sidelink (SL) communications scheme, in accordance with various aspects of the present disclosure.

FIG. 7 is a diagram illustrating an example of a relay-based sidelink network, in accordance with various aspects of the present disclosure

FIG. 8 is a timing diagram illustrating an example of forming a sidelink relay network, in accordance with various aspects of the present disclosure.

FIG. 9 is a block diagram illustrating an example wireless communication device that supports configuring a sidelink relay network, in accordance with various aspects of the present disclosure.

FIG. 10 is a flow diagram illustrating an example process performed by a relay node, in accordance with various aspects of the present disclosure.

FIG. 11 is a block diagram illustrating an example wireless communication device that supports configuring a sidelink relay network, in accordance with various aspects of the present disclosure.

FIG. 12 is a flow diagram illustrating an example of a process performed by a wireless device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology associated with 5G wireless technologies, aspects of the present disclosure can be applied in later generations, including for 6G wireless technologies, or in other wireless communications systems.

In cellular communications networks, wireless devices may generally communicate with each other via access links with one or more network entities such as a base station or scheduling entity. Some cellular networks may also support device-to-device (D2D) communications that enable discovery of, and communications among, nearby devices using direct links between devices (for example, without passing through a base station, relay, or other network entity). D2D communications may also be referred to as point-to-point (P2P) or sidelink communications. D2D communications may be implemented using licensed or unlicensed bands. Using D2D communications, devices can avoid some of the overhead that would otherwise be involved with routing to and from a network entity. D2D communications can also enable mesh networking and device-to-network relay functionality.

Vehicle-to-everything (V2X) communication is an example of D2D communication that is specifically geared toward automotive use cases. V2X communications may enable autonomous vehicles to communicate with each other. In some examples, V2X communications may enable a group of autonomous vehicles to share respective sensor information. For example, each autonomous vehicle may include multiple sensors or sensing technologies (for example, light detection and ranging (LiDAR), radar, cameras, etc.). In most cases, an autonomous vehicle's sensors are limited to detecting objects within the sensors'line of sight. In contrast, based on the sensor information shared via V2X communications, one or more autonomous vehicles in the group of autonomous vehicles may be made aware of an out of sight object. In such examples, the object may be within a line of sight of sensors associated with another autonomous vehicle in the group of autonomous vehicles. Additionally, or alternatively, based on the sensor information shared via V2X communications, two or more autonomous vehicle in the group of autonomous vehicles may coordinate one or more actions, such as avoiding the object or maintaining a pre-determined distance between the two or more autonomous vehicles.

Sidelink (SL) communication is another example of D2D communication that enables a user equipment (UE) to communicate with another UE without tunneling through a base station and/or a core network. Sidelink communications can be communicated over a physical sidelink control channel (PSCCH) and a physical sidelink shared channel (PSSCH). The PSCCH and PSSCH are similar to a physical downlink control channel (PDCCH) and a physical downlink shared channel (PDSCH) in downlink (DL) communications between a base station and a UE. For instance, the PSCCH may carry sidelink control information (SCI) and the PSCCH may carry sidelink data (for example, user data). Each PSCCH is associated with a corresponding PSSCH, where SCI in a PSCCH may carry reservation and/or scheduling information for a sidelink data transmission in the associated PSSCH. Use cases for sidelink communications may include, among others, V2X, industrial IoT (IIoT), and/or NR-lite.

Some wireless communication systems may include a donor network node that communicates with one or more destination nodes, such as destination UEs, via one or more relay nodes. In conventional relay networks, a relay node may communicate with the donor network node via a backhaul link and with destination UEs via respective access links. In such conventional relay networks, the relay node may receive downlink messages from the donor network node over the backhaul link and relay these downlink messages to the destination nodes over the access links. Similarly, the relay node may receive uplink messages from the destination nodes via the access links and relay these messages to the donor network node via the backhaul link. In some examples, the relay node may be used to improve spectral efficiency. Additionally, or alternatively, the relay node may extend network coverage. In some relay networks, the relay node may be a sidelink device, such as a roadside unit (RSU) or a sidelink UE. Such relay networks may be an example of a sidelink relay network (or relay-based sidelink network). In a relay-based sidelink network, the donor network node may communicate with the relay node via a cellular interface (for example, a Uu interface) or a sidelink interface (for example, a PC5 interface). The relay node may communicate with the destination nodes via a sidelink interface. In some examples, the donor network node may be associated with multiple sidelink relay networks. Each of the sidelink relay networks may include one or more relay nodes and one or more destination nodes. The donor network node may initialize and configure each sidelink relay network based on determining that one or more relay network conditions are satisfied.

Aspects of the present disclosure generally relate to wireless communication, and specifically to configuring a sidelink relay network. In some examples, a group of relay nodes may be within a coverage area of a donor network node. In some such examples, the donor network node may transmit, to the group of relay nodes, a relay network message indicating configuration information associated with one sidelink relay network of multiple sidelink relay networks associated with the donor network node. The sidelink relay network may include a set of relay nodes of the group of relay nodes and a set of destination nodes. In some examples, each relay node of the group of relay nodes that is not included in the set of relay nodes may be associated with another sidelink relay network of the multiple sidelink relay networks associated with the donor network node. Each relay node in the set of relay nodes may establish a respective sidelink communication link with each of one or more destination nodes in the set of destination nodes based on the configuration information. In some examples, the donor network node may receive, from each relay node in the set of relay nodes, a respective queue report message indicating one or more channel characteristics and queue information. The donor network node may then transmit, to each relay node in the set of relay nodes, a single resource allocation message based on the channel characteristics and queue information received from the set of relay nodes. The resource allocation message indicates a group of resources, allocated among the set of relay nodes, to be used by the set of relay nodes for communicating with the set of destination nodes via respective sidelink communication links. The group of resources may be allocated among the set of relay nodes based on an order of transmissions from the set of relay nodes, respective priorities of the relay nodes, or respective slots reserved by the relay nodes. In some examples, more resources may be allocated to relay nodes associated with sidelink communication links having greater throughputs than throughputs of sidelink communication links associated with other relay nodes in the set of relay nodes.

Particular aspects of the subject matter described in this disclosure may be implemented to realize one or more of the following potential advantages. In some examples, the described techniques may increase sidelink network throughput by prioritizing transmissions from particular relay nodes. Additionally or alternatively, some of the described techniques may increase sidelink network throughput by exploiting the queue information received from the set of relay nodes to utilize spatial diversity or multi-hop diversity. The increased sidelink network throughput may improve a quality of high throughput applications, such as video streaming, in the sidelink relay network.

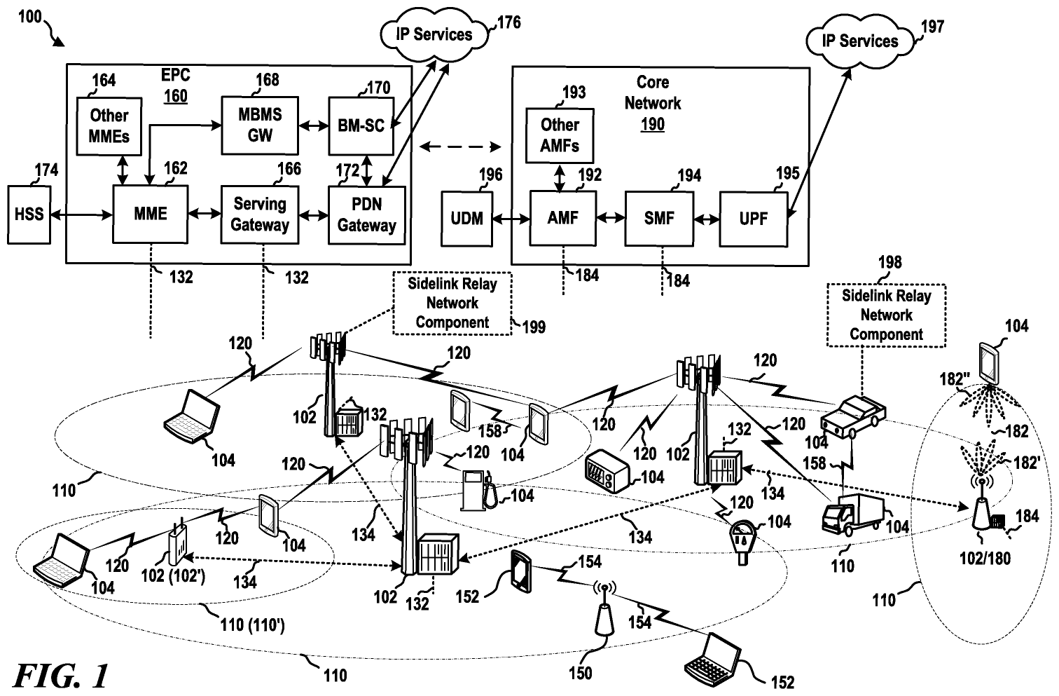

FIG. 1 is a diagram illustrating an example of a wireless communications system and an access network 100. The wireless communications system (also referred to as a wireless wide area network (WWAN)) includes base stations 102, UEs 104, an evolved packet core (EPC) 160, and another core network 190 (for example, a 5G core (5GC)). The base stations 102 may include macrocells (high power cellular base station) and/or small cells 102′ (low power cellular base station). The macrocells include base stations. The small cells 102′ include femtocells, picocells, and microcells.

The base stations 102 configured for 4G LTE (collectively referred to as evolved universal mobile telecommunications system (UMTS) terrestrial radio access network (E-UTRAN)) may interface with the EPC 160 through backhaul links 132 (for example, SI interface). The base stations 102 configured for 5G NR (collectively referred to as next generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (for example, handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (for example, through the EPC 160 or core network 190) with each other over backhaul links 134 (for example, X2 interface). The backhaul links 134 may be wired or wireless.

The base stations 102 may wirelessly communicate with the UEs 104. Each of the base stations 102 may provide communications coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include home evolved Node Bs (eNBs) (HeNBs), which may provide service to a restricted group known as a closed subscriber group (CSG). The communications links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communications links 120 may use multiple-input and multiple-output (MIMO) antenna technology, including spatial multiplexing, beamforming, and/or transmit diversity. The communications links may be through one or more carriers. The base stations 102/UEs 104 may use spectrum up to Y MHz (for example, 5, 10, 15, 20, 100, 400, etc., MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (for example, more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communications link 158. The D2D communications link 158 may use the DL/UL WWAN spectrum. The D2D communications link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communications may be through a variety of wireless D2D communications systems, such as FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communications links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (for example, macro base station), may include a NR BS, a Node B, a 5G node B, an eNB, a gNodeB (gNB), an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC. Some base stations, such as gNB 180 may operate in a traditional sub 6 GHz spectrum, in millimeter wave (mm Wave) frequencies, and/or near mm Wave frequencies in communication with the UE 104. When the gNB 180 operates in mm Wave or near mm Wave frequencies, the gNB 180 may be referred to as an mm Wave base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmWave may extend down to a frequency of 3 GHz with a wavelength of 100 millimeters. The super high frequency (SHF) band extends between 3 GHz and 30 GHz, also referred to as centimeter wave. Communications using the mmWave/near mm Wave radio frequency band (for example, 3 GHZ-300 GHz) has extremely high path loss and a short range. The mm Wave base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a mobility management entity (MME) 162, other MMEs 164, a serving gateway 166, a multimedia broadcast multicast service (MBMS) gateway 168, a broadcast multicast service center (BM-SC) 170, and a packet data network (PDN) gateway 172. The MME 162 may be in communication with a home subscriber server (HSS) 174. The MME 162 is the control node that processes the signaling between the UEs 104 and the EPC 160. Generally, the MME 162 provides bearer and connection management. All user Internet protocol (IP) packets are transferred through the serving gateway 166, which itself is connected to the PDN gateway 172. The PDN gateway 172 provides UE IP address allocation as well as other functions. The PDN gateway 172 and the BM-SC 170 are connected to the IP services 176. The IP services 176 may include the Internet, an intranet, an IP multimedia subsystem (IMS), a PS streaming service, and/or other IP services. The BM-SC 170 may provide functions for MBMS user service provisioning and delivery. The BM-SC 170 may serve as an entry point for content provider MBMS transmission, may be used to authorize and initiate MBMS bearer services within a public land mobile network (PLMN), and may be used to schedule MBMS transmissions. The MBMS gateway 168 may be used to distribute MBMS traffic to the base stations 102 belonging to a multicast broadcast single frequency network (MBSFN) area broadcasting a particular service, and may be responsible for session management (start/stop) and for collecting evolved MBMS (eMBMS) related charging information.

The core network 190 may include an access and mobility management function (AMF) 192, other AMFs 193, a session management function (SMF) 194, and a user plane function (UPF) 195. The AMF 192 may be in communication with a unified data management (UDM) 196. The AMF 192 is the control node that processes the signaling between the UEs 104 and the core network 190. Generally, the AMF 192 provides quality of service (QOS) flow and session management. All user Internet protocol (IP) packets are transferred through the UPF 195. The UPF 195 provides UE IP address allocation as well as other functions. The UPF 195 is connected to the IP services 197. The IP services 197 may include the Internet, an intranet, an IP multimedia subsystem (IMS), a PS streaming service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit and receive point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (for example, MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (for example, a parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

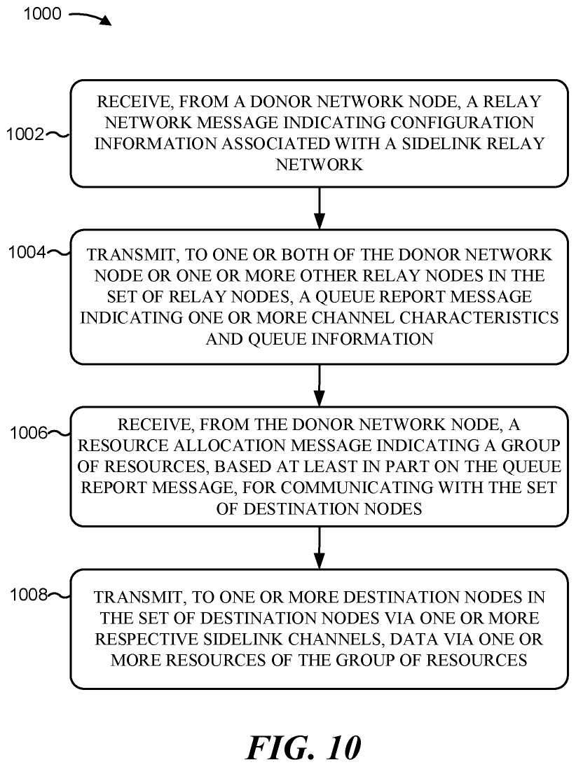

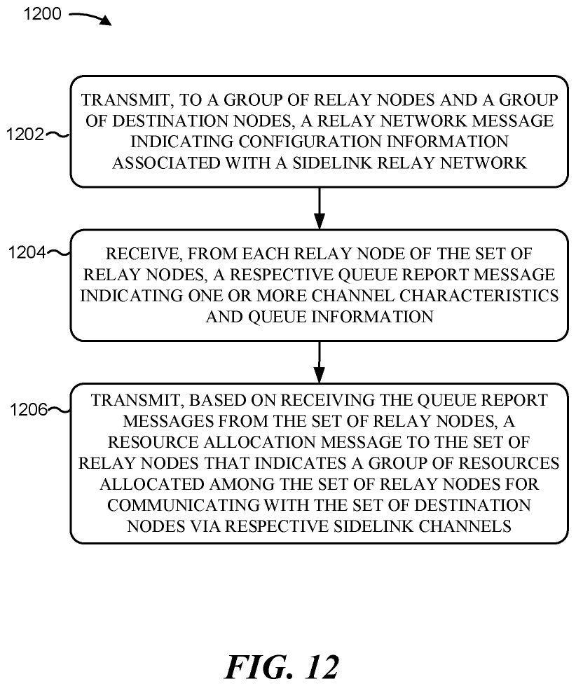

Referring again to FIG. 1, the UE 104 may include a sidelink relay component 198 configured to perform the operations disclosed with reference to FIG. 10. The base station 102 may include a sidelink relay component 199 configured to perform the operations disclosed with reference to FIG. 12.

Although the following description may be focused on 5G NR, it may be applicable to other similar areas, such as LTE, LTE-A, CDMA, GSM, and other wireless technologies.

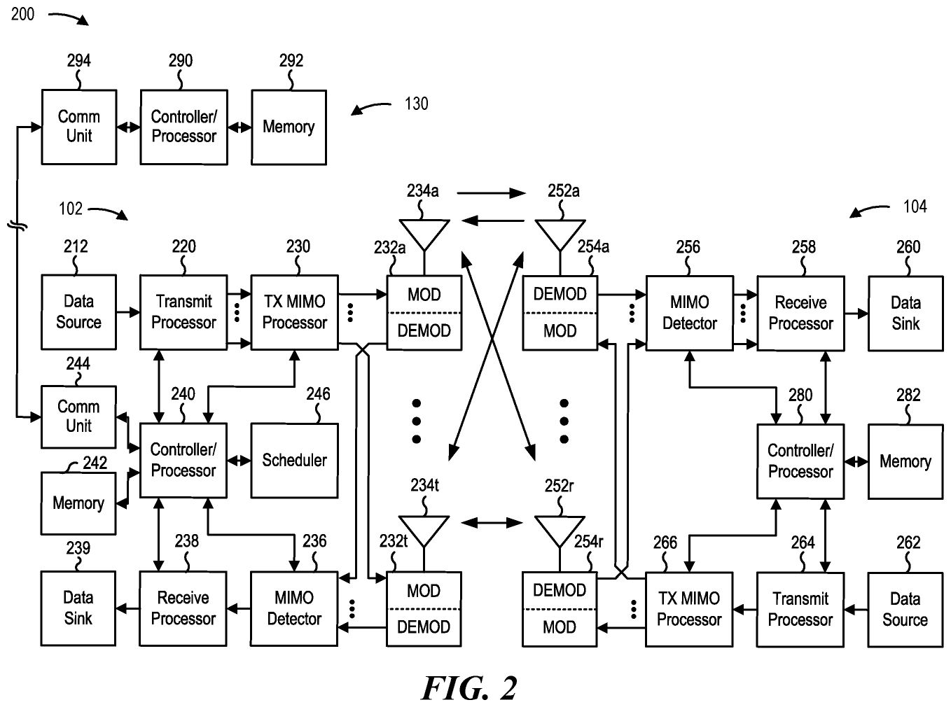

FIG. 2 shows a block diagram of a design 200 of the base station 102 and UE 104, which may be one of the base stations and one of the UEs in FIG. 1, respectively. The base station 102 may be equipped with T antennas 234a through 234t, and UE 104 may be equipped with R antennas 252a through 252r, where in general T≥1 and R≥1.

At the base station 102, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 232t, respectively. According to various aspects described in more detail below, the synchronization signals can be generated with location encoding to convey additional information.

At the UE 104, antennas 252a through 252r may receive the downlink signals from the base station 102 and/or other base stations and may provide received signals to demodulators (DEMODs) 254a through 252r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 252r, perform MIMO detection on the received symbols if applicable, and provide detected symbols. A receive processor 258 may process (for example, demodulate and decode) the detected symbols, provide decoded data for the UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 104 may be included in a housing.

On the uplink, at the UE 104, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for DFT-s-OFDM, CP-OFDM, and/or the like), and transmitted to the base station 102. At the base station 102, the uplink signals from the UE 104 and other UEs may be received by the antennas 234, processed by the demodulators 254, detected by a MIMO detector 236 if applicable, and further processed by a receive processor 238 to obtain decoded data and control information sent by the UE 104. The receive processor 238 may provide the decoded data to a data sink 239 and the decoded control information to a controller/processor 240. The base station 102 may include communications unit 244 and communicate to the core network 130 via the communications unit 244. The core network 130 may include a communications unit 294, a controller/processor 290, and a memory 292.

The controller/processor 240 of the base station 102, the controller/processor 280 of the UE 104, and/or any other component(s) of FIG. 2 may perform one or more techniques associated with configuring a relay-based sidelink network as described in more detail elsewhere. For example, the controller/processor 240 of the base station 102, the controller/processor 280 of the UE 104, and/or any other component(s) of FIG. 2 may perform or direct operations of, for example, the processes of FIGS. 10 and 12 and/or other processes as described. Memories 242 and 282 may store data and program codes for the base station 102 and UE 104, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

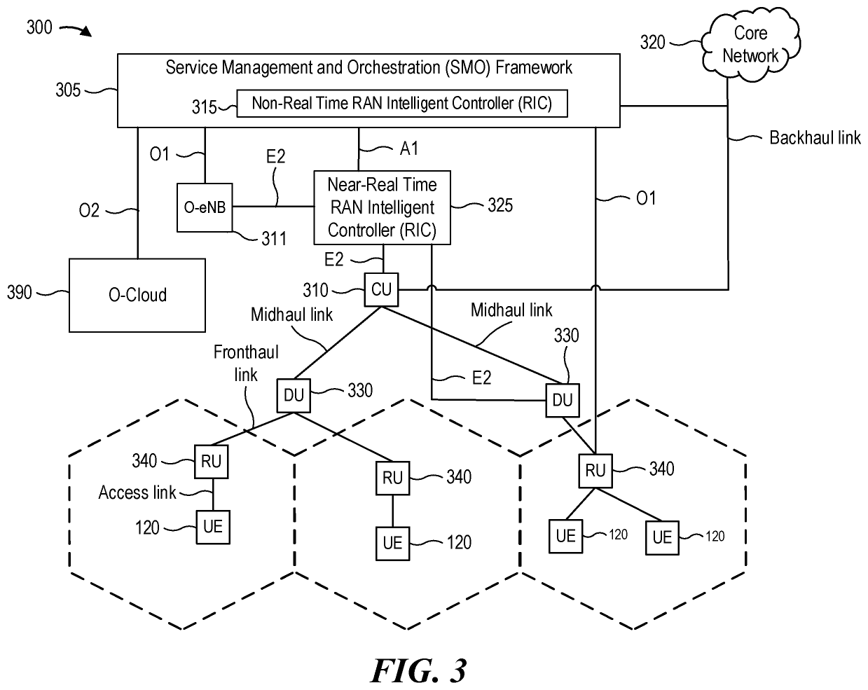

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit—user plane (CU-UP)), control plane functionality (for example, central unit—control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

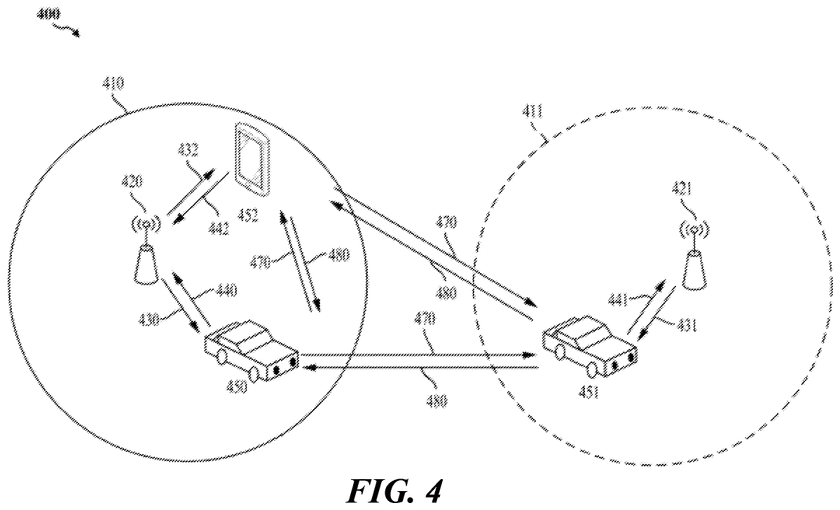

FIG. 4 is a diagram of a device-to-device (D2D) communications system 400, including V2X communications, in accordance with various aspects of the present disclosure. For example, the D2D communications system 400 may include V2X communications, (for example, a first UE 450 communicating with a second UE 451). In some aspects, one or both of the first UE 450 or the second UE 451 may be configured to communicate in a one or both of licensed radio frequency spectrum or a shared radio frequency spectrum. The UEs 450, 451, and 452 may be examples of a UE 104 described with reference to FIGS. 1, 2, and 3. The shared radio frequency spectrum may be unlicensed, and therefore multiple different technologies may use the shared radio frequency spectrum for communications, including new radio (NR), LTE, LTE-Advanced, licensed assisted access (LAA), dedicated short range communications (DSRC), MuLTEFire, 4G, and the like. The foregoing list of technologies is to be regarded as illustrative, and is not meant to be exhaustive.

The D2D communications system 400 may use NR radio access technology. Of course, other radio access technologies, such as LTE radio access technology, may be used. In D2D communications (for example, V2X communications or vehicle-to-vehicle (V2V) communications), the UEs 450, 451 may be on networks of different mobile network operators (MNOs). Each of the networks may operate in its own radio frequency spectrum. For example, the air interface to a first UE 450 (for example, Uu interface) may be on one or more frequency bands different from the air interface of the second UE 451. The first UE 450 and the second UE 451 may communicate via a sidelink component carrier, for example, via the PC5 interface. In some examples, the MNOs may schedule sidelink communications between or among the UEs 450, 451 in licensed radio frequency spectrum and/or a shared radio frequency spectrum (for example, 5 GHz radio spectrum bands).

The shared radio frequency spectrum may be unlicensed, and therefore different technologies may use the shared radio frequency spectrum for communications. In some aspects, a D2D communications (for example, sidelink communications) between or among UEs 450, 451 is not scheduled by MNOs. The D2D communications system 400 may further include a third UE 452.

The third UE 452 may operate on the first network 410 (for example, of the first MNO) or another network, for example. The third UE 452 may be in D2D communications with the first UE 450 and/or second UE 451. The first base station 420 (for example, gNB) may communicate with the third UE 452 via a downlink (DL) carrier 432 and/or an uplink (UL) carrier 442. The base stations 420 and 421 may be examples of a base station 102 described with reference to FIGS. 1 and 2, or a CU 310, DU 330, or RU 340 described with reference to FIG. 3. The DL communications may be use various DL resources (for example, the DL subframes and/or the DL channels). The UL communications may be performed via the UL carrier 442 using various UL resources (for example, the UL subframes and the UL channels).

The first network 410 operates in a first frequency spectrum and includes the first base station 420 (for example, gNB) communicating at least with the first UE 450. The first base station 420 (for example, gNB) may communicate with the first UE 450 via a DL carrier 430 and/or an UL carrier 440. The DL communications may be use various DL resources (for example, the DL subframes and/or the DL channels). The UL communications may be performed via the UL carrier 440 using various UL resources (for example, the UL subframes and the UL channels).

In some aspects, the second UE 451 may be on a different network from the first UE 450. In some aspects, the second UE 451 may be on a second network 411 (for example, of the second MNO). The second network 411 may operate in a second frequency spectrum (for example, a second frequency spectrum different from the first frequency spectrum) and may include the second base station 421 (for example, gNB) communicating with the second UE 451.

The second base station 421 may communicate with the second UE 451 via a DL carrier 431 and an UL carrier 441. The DL communications are performed via the DL carrier 431 using various DL resources (for example, the DL subframes (FIG. 2A) and/or the DL channels (FIG. 2B)). The UL communications are performed via the UL carrier 441 using various UL resources (for example, the UL subframes (FIG. 2C) and/or the UL channels (FIG. 2D)).

In conventional systems, the first base station 420 and/or the second base station 421 assign resources to the UEs for device-to-device (D2D) communications (for example, V2X communications and/or V2V communications). For example, the resources may be a pool of UL resources, both orthogonal (for example, one or more frequency division multiplexing (FDM) channels) and non-orthogonal (for example, code division multiplexing (CDM)/resource spread multiple access (RSMA) in each channel). The first base station 420 and/or the second base station 421 may configure the resources via the PDCCH (for example, faster approach) or RRC (for example, slower approach).

In some systems, each UE 450, 451 autonomously selects resources for D2D communications. For example, each UE 450, 451 may sense and analyze channel occupation during the sensing window. The UEs 450, 451 may use the sensing information to select resources from the sensing window. As discussed, one UE 451 may assist another UE 450 in performing resource selection. The UE 451 providing assistance may be referred to as the receiver UE or partner UE, which may potentially notify the transmitter UE 450. The transmitter UE 450 may transmit information to the receiving UE 451 via sidelink communications.

The D2D communications (for example, V2X communications and/or V2V communications) may be carried out via one or more sidelink carriers 470, 480. The one or more sidelink carriers 470, 480 may include one or more channels, such as a physical sidelink broadcast channel (PSBCH), a physical sidelink discovery channel (PSDCH), a physical sidelink shared channel (PSSCH), and a physical sidelink control channel (PSCCH), for example.

In some examples, the sidelink carriers 470, 480 may operate using the PC5 interface. The first UE 450 may transmit to one or more (for example, multiple) devices, including to the second UE 451 via the first sidelink carrier 470. The second UE 451 may transmit to one or more (for example, multiple) devices, including to the first UE 450 via the second sidelink carrier 480.

In some aspects, the UL carrier 440 and the first sidelink carrier 470 may be aggregated to increase bandwidth. In some aspects, the first sidelink carrier 470 and/or the second sidelink carrier 480 may share the first frequency spectrum (with the first network 410) and/or share the second frequency spectrum (with the second network 411). In some aspects, the sidelink carriers 470, 480 may operate in an unlicensed/shared radio frequency spectrum.

In some aspects, sidelink communications on a sidelink carrier may occur between the first UE 450 and the second UE 451. In an aspect, the first UE 450 may perform sidelink communications with one or more (for example, multiple) devices, including the second UE 451 via the first sidelink carrier 470. For example, the first UE 450 may transmit a broadcast transmission via the first sidelink carrier 470 to the multiple devices (for example, the second and third UEs 451, 452). The second UE 451 (for example, among other UEs) may receive such broadcast transmission. Additionally or alternatively, the first UE 450 may transmit a multicast transmission via the first sidelink carrier 470 to the multiple devices (for example, the second and third UEs 451, 452). The second UE 451 and/or the third UE 452 (for example, among other UEs) may receive such multicast transmission. The multicast transmissions may be connectionless or connection-oriented. A multicast transmission may also be referred to as a groupcast transmission.

Furthermore, the first UE 450 may transmit a unicast transmission via the first sidelink carrier 470 to a device, such as the second UE 451. The second UE 451 (for example, among other UEs) may receive such unicast transmission. Additionally or alternatively, the second UE 451 may perform sidelink communications with one or more (for example, multiple) devices, including the first UE 450 via the second sidelink carrier 480. For example, the second UE 451 may transmit a broadcast transmission via the second sidelink carrier 480 to the multiple devices. The first UE 450 (for example, among other UEs) may receive such broadcast transmission.

In another example, the second UE 451 may transmit a multicast transmission via the second sidelink carrier 480 to the multiple devices (for example, the first and third UEs 450, 452). The first UE 450 and/or the third UE 452 (for example, among other UEs) may receive such multicast transmission. Further, the second UE 451 may transmit a unicast transmission via the second sidelink carrier 480 to a device, such as the first UE 450. The first UE 450 (for example, among other UEs) may receive such unicast transmission. The third UE 452 may communicate in a similar manner.

In some aspects, for example, such sidelink communications on a sidelink carrier between the first UE 450 and the second UE 451 may occur without having MNOs allocating resources (for example, one or more portions of a resource block (RB), slot, frequency band, and/or channel associated with a sidelink carrier 470, 480) for such communications and/or without scheduling such communications. Sidelink communications may include traffic communications (for example, data communications, control communications, paging communications and/or system information communications). Further, sidelink communications may include sidelink feedback communications associated with traffic communications (for example, a transmission of feedback information for previously-received traffic communications). Sidelink communications may employ at least one sidelink communications structure having at least one feedback symbol. The feedback symbol of the sidelink communications structure may allot for any sidelink feedback information that may be communicated in the device-to-device (D2D) communications system 400 between devices (for example, a first UE 450, a second UE 451, and/or a third UE 452). As discussed, a UE may be a vehicle (for example, UE 450, 451), a mobile device (for example, 452), or another type of device. In some cases, a UE may be a special UE, such as a roadside unit (RSU).

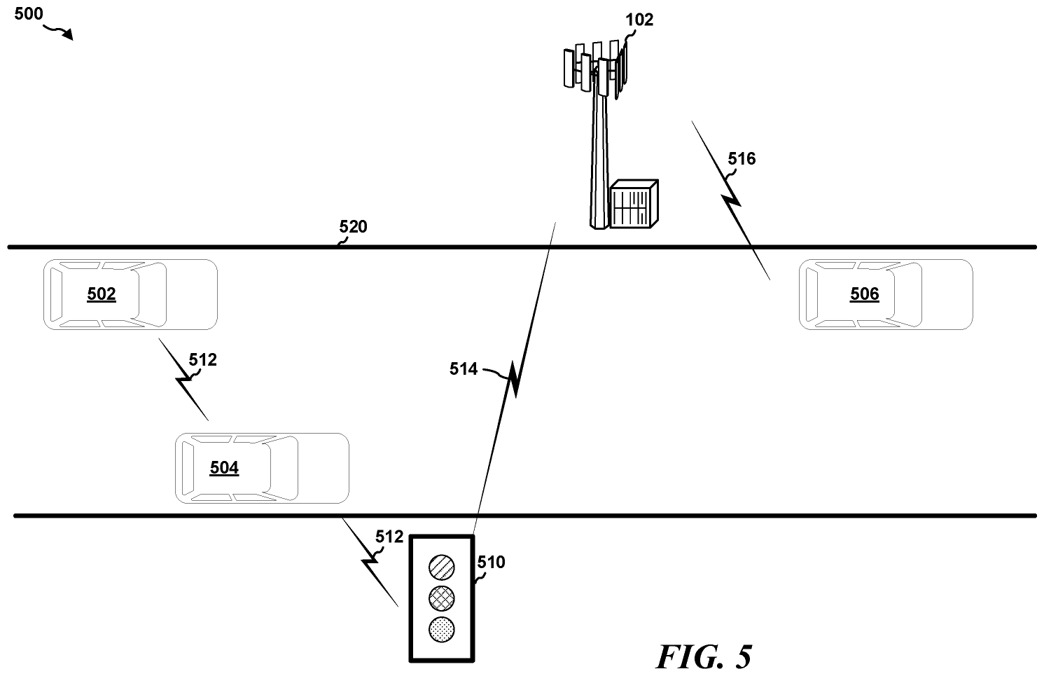

FIG. 5 illustrates an example of a vehicle-to-everything (V2X) system with a roadside unit (RSU), according to aspects of the present disclosure. As shown in FIG. 5, V2X system 500 includes a transmitter UE 504 transmits data to an RSU 510 and a receiving UE 502 via sidelink transmissions 512. The UEs 502, 504, and 506 may be examples of a UE 104 described with reference to FIGS. 1, 2, and 3. Additionally, or alternatively, the RSU 510 may transmit data to the transmitter UE 504 via a sidelink transmission 512. The RSU 510 may forward data received from the transmitter UE 504 to a cellular network base station (for example, gNB) 102 via an UL transmission 514. The gNB 508 may transmit the data received from the RSU 510 to other UEs 506 via a DL transmission 516. The RSU 510 may be incorporated with traffic infrastructure (for example, traffic light, light pole, etc.) For example, as shown in FIG. 5, the RSU 510 is a traffic signal positioned at a side of a road 520. Additionally or alternatively, RSUs 510 may be stand-alone units.

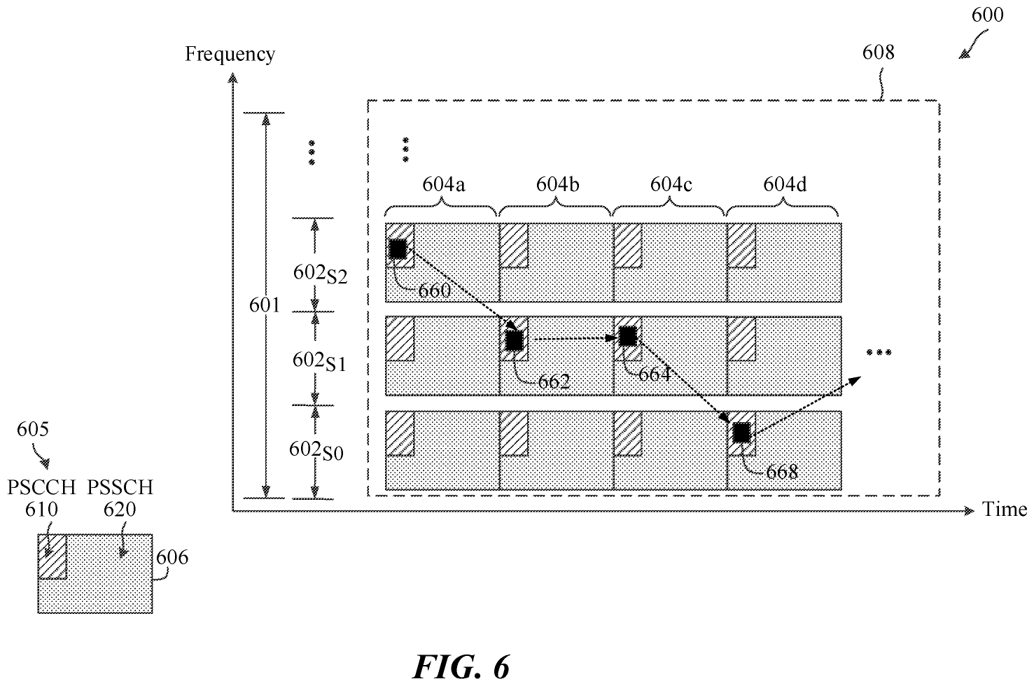

FIG. 6 is a graph illustrating a sidelink (SL) communications scheme, in accordance with various aspects of the present disclosure. A scheme 600 may be employed by UEs such as the UEs 104 in a network such as the network 100. In FIG. 6, the x-axis represents time and the y-axis represents frequency. The CV2X channels may be for 3GPP Release 16 and beyond.

In the scheme 600, a shared radio frequency band 601 is partitioned into multiple subchannels or frequency subbands 602 (shown as 602S0, 602S1, 602S2) in frequency and multiple sidelink frames 604 (shown as 604a, 604b, 604c, 604d) in time for sidelink communications. The frequency band 601 may be at any suitable frequencies. The frequency band 601 may have any suitable bandwidth (BW) and may be partitioned into any suitable number of frequency subbands 602. The number of frequency subbands 602 can be dependent on the sidelink communications BW requirement.

Each sidelink frame 604 includes a sidelink resource 606 in each frequency subband 602. A legend 605 indicates the types of sidelink channels within a sidelink resource 606. In some instances, a frequency gap or guard band may be specified between adjacent frequency subbands 602, for example, to mitigate adjacent band interference. The sidelink resource 606 may have a substantially similar structure as an NR sidelink resource. For instance, the sidelink resource 606 may include a number of subcarriers or RBs in frequency and a number of symbols in time. In some instances, the sidelink resource 606 may have a duration between about one millisecond (ms) to about 20 ms. Each sidelink resource 606 may include a PSCCH 610 and a PSSCH 620. The PSCCH 610 and the PSSCH 620 can be multiplexed in time and/or frequency. The PSCCH 610 may be for part one of a control channel (CCH), with the second part arriving as a part of the shared channel allocation. In the example of FIG. 6, for each sidelink resource 606, the PSCCH 610 is located during the beginning symbol(s) of the sidelink resource 606 and occupies a portion of a corresponding frequency subband 602, and the PSSCH 620 occupies the remaining time-frequency resources in the sidelink resource 606. In some instances, a sidelink resource 606 may also include a physical sidelink feedback channel (PSFCH), for example, located during the ending symbol(s) of the sidelink resource 606. In general, a PSCCH 610, a PSSCH 620, and/or a PSFCH may be multiplexed within a sidelink resource 606.

The PSCCH 610 may carry SCI 660 and/or sidelink data. The sidelink data can be of various forms and types depending on the sidelink application. For instance, when the sidelink application is a V2X application, the sidelink data may carry V2X data (for example, vehicle location information, traveling speed and/or direction, vehicle sensing measurements, etc.). Alternatively, when the sidelink application is an IloT application, the sidelink data may carry IIoT data (for example, sensor measurements, device measurements, temperature readings, etc.). The PSFCH can be used for carrying feedback information, for example, hybrid automatic repeat request (HARQ) acknowledgment/negative acknowledgment (ACK/NACK) for sidelink data received in an earlier sidelink resource 606.

In an NR sidelink frame structure, the sidelink frames 604 in a resource pool 608 may be contiguous in time. A sidelink UE (for example, the UEs 104) may include, in SCI 660, a reservation for a sidelink resource 606 in a later sidelink frame 604. Thus, another sidelink UE (for example, a UE in the same NR-U sidelink system) may perform SCI sensing in the resource pool 608 to determine whether a sidelink resource 606 is available or occupied. For instance, if the sidelink UE detected SCI indicating a reservation for a sidelink resource 606, the sidelink UE may refrain from transmitting in the reserved sidelink resource 606. If the sidelink UE determines that there is no reservation detected for a sidelink resource 606, the sidelink UE may transmit in the sidelink resource 606. As such, SCI sensing can assist a UE in identifying a target frequency subband 602 to reserve for sidelink communications and to avoid intra-system collision with another sidelink UE in the NR sidelink system. In some aspects, the UE may be configured with a sensing window for SCI sensing or monitoring to reduce intra-system collision.

In some aspects, the sidelink UE may be configured with a frequency hopping pattern. In this regard, the sidelink UE may hop from one frequency subband 602 in one sidelink frame 604 to another frequency subband 602 in another sidelink frame 604. In the illustrated example of FIG. 6, during the sidelink frame 604a, the sidelink UE transmits SCI 660 in the sidelink resource 606 located in the frequency subband 602S2 to reserve a sidelink resource 606 in a next sidelink frame 604b located at the frequency subband 602S1. Similarly, during the sidelink frame 604b, the sidelink UE transmits SCI 662 in the sidelink resource 606 located in the frequency subband 602S1 to reserve a sidelink resource 606 in a next sidelink frame 604c located at the frequency subband 602S1. During the sidelink frame 604c, the sidelink UE transmits SCI 664 in the sidelink resource 606 located in the frequency subband 602S1 to reserve a sidelink resource 606 in a next sidelink frame 604d located at the frequency subband 602S0. During the sidelink frame 604d, the sidelink UE transmits SCI 668 in the sidelink resource 606 located in the frequency subband 602S0. The SCI 668 may reserve a sidelink resource 606 in a later sidelink frame 604.

The SCI can also indicate scheduling information and/or a destination identifier (ID) identifying a target receiving sidelink UE for the next sidelink resource 606. Thus, a sidelink UE may monitor SCI transmitted by other sidelink UEs. Upon detecting SCI in a sidelink resource 606, the sidelink UE may determine whether the sidelink UE is the target receiver based on the destination ID. If the sidelink UE is the target receiver, the sidelink UE may proceed to receive and decode the sidelink data indicated by the SCI. In some aspects, multiple sidelink UEs may simultaneously communicate sidelink data in a sidelink frame 604 in different frequency subband (for example, via frequency division multiplexing (FDM)). For instance, in the sidelink frame 604b, one pair of sidelink UEs may communicate sidelink data using a sidelink resource 606 in the frequency subband 602S2 while another pair of sidelink UEs may communicate sidelink data using a sidelink resource 606 in the frequency subband 602S1.

In some aspects, the scheme 600 is used for synchronous sidelink communications. That is, the sidelink UEs may be synchronized in time and are aligned in terms of symbol boundary, sidelink resource boundary (for example, the starting time of sidelink frames 604). The sidelink UEs may perform synchronization in a variety of forms, for example, based on sidelink synchronization signal blocks (SSBs) received from a sidelink UE and/or NR-U SSBs received from a base station (for example, the base station 102) while in-coverage of the base station. In some aspects, the sidelink UE may be preconfigured with the resource pool 608 in the frequency band 601, for example, while in coverage of a serving base station. The resource pool 608 may include a plurality of sidelink resources 606. The base station can configure the sidelink UE with a resource pool configuration indicating resources in the frequency band 601 and/or the subbands 602 and/or timing information associated with the sidelink frames 604. In some aspects, the scheme 600 includes mode-2 RRA (for example, supporting autonomous radio resource allocation (RRA) that can be used for out-of-coverage sidelink UEs or partial-coverage sidelink UEs).

As discussed, in some relay networks, such as a relay-based sidelink network, a relay node may be a sidelink device, such as an RSU or a sidelink UE. In such networks, the donor network node may communicate with the relay node via a cellular interface (for example, Uu interface) or a sidelink interface (for example, PC5 interface). Additionally, the relay node may communicate with the one or more destination UEs via the sidelink interface. Each destination UE may be associated with a respective destination UE ID. In some examples, the relay node may report each destination UE ID to the donor network node. In some such examples, a core network, such as the core network 190 as described with respect to FIG. 1, may authorize each destination UE. Each authorized destination UE may be associated with a relay-based sidelink network.

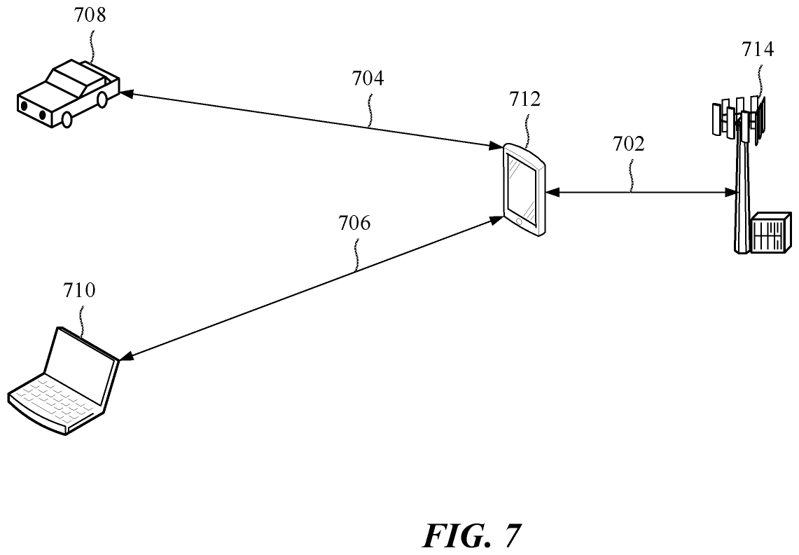

FIG. 7 is a diagram illustrating an example of a relay-based sidelink network 700, in accordance with various aspects of the present disclosure. For ease of explanation, the relay-based sidelink network 700 may be described as a sidelink relay network 700. As shown in the example of FIG. 7, the sidelink relay network 700 may include a donor network node 714, a relay node 712, a first destination node 708, and a second destination node 710. The donor network node 714 may be an example of a base station 102 as described with reference to FIG. 1, a CU 310, DU 330, or RU 340 as described with reference to FIG. 3, or a base station 420 or 421 as described with reference to FIG. 4. The relay node 712 may be an example of a UE 104 as described with reference to FIGS. 1, 2, and 3, a UE 450, 451, or 452 as described with reference to FIG. 4, a UE 502, 504, or 506 or an RSU 510 as described with reference to FIG. 5. The destination nodes 708 and 710 may be an example of a UE 104 as described with reference to FIGS. 1, 2, and 3, a UE 450, 451, or 452 as described with reference to FIG. 4, a UE 502, 504, or 506 as described with reference to FIG. 5.

In the example of FIG. 7, the relay node 712 and the donor network node 714 may communicate via a first communication link 702, which may be a cellular channel (for example, Uu channel) or a sidelink channel. Additionally, the relay node 712 may establish a respective communication link 704 and 706 with each of the destination nodes 708 and 710. Each communication link 704 and 706 may be established via one or more respective sidelink channels. The sidelink relay network 700 is not limited to one relay node 712, additional relay nodes may be deployed within the sidelink relay network 700. Additionally, the sidelink relay network 700 is not limited to two destination nodes 708 and 710. The sidelink relay network 700 may include one or more destination nodes.

The relay node 712 may include a buffer that stores packets received from the donor network node 714. The buffer may include one queue for each destination UE 708 and 710. In some examples, the buffer in the relay node 712 may be used for spatial diversity or multi-hop diversity to increase network throughput. The increased throughput may be useful in high throughput applications, such as video streaming. In such examples, a scheduler, such as a donor network node 714 or a core network 190 (not shown in FIG. 7), may prioritize transmissions from one relay node over other relay nodes in the sidelink relay network 700 based on a quality of one or more channel characteristics of one or more communication links associated with the one relay node. Various scheduling approaches may be specified for the sidelink relay network. In some examples, a scheduling approach may be a modified max-weight (MMW) scheduling policy, maximum differential backlog (MDB), a maximum sum backlog (MSB) scheduling policy, or a proportional fair (PF) scheduling policy.

In some examples, it may be assumed that a sidelink relay network includes a fixed number of queues (for example, buffers). In such examples, it may also be assumed that a data arrival process is a stationary ergodic process, such that statistical properties associated with the data arrival process may not change over time. The data arrival process refers to the process of data arriving at each relay node from the donor network node. In some examples, data transmissions may be associated with a bounded delay. Therefore, a scheduling policy may be specified to stabilize relay node queues. By stabilizing the relay node queues, average data departure rates of all buffers may be equal to average data arrival rates, and consequently, the packets received at each relay node may be delivered to respective destination nodes with a finite average delay.

For some scheduling policies, such as MMW, MDB, MSB, and PF, a scheduler may monitor a queue size at a relay node, per destination, in each of the buffers, as well as one or more channel characteristics (for example, channel conditions). Some scheduling policies, such as MMW, MDB, and MSB, may use a central controller, such as a donor network node. Other scheduling policies, such as PF, may not use a central controller because the relay nodes and the destination devices associated with the sidelink relay network may share channel information with each other.

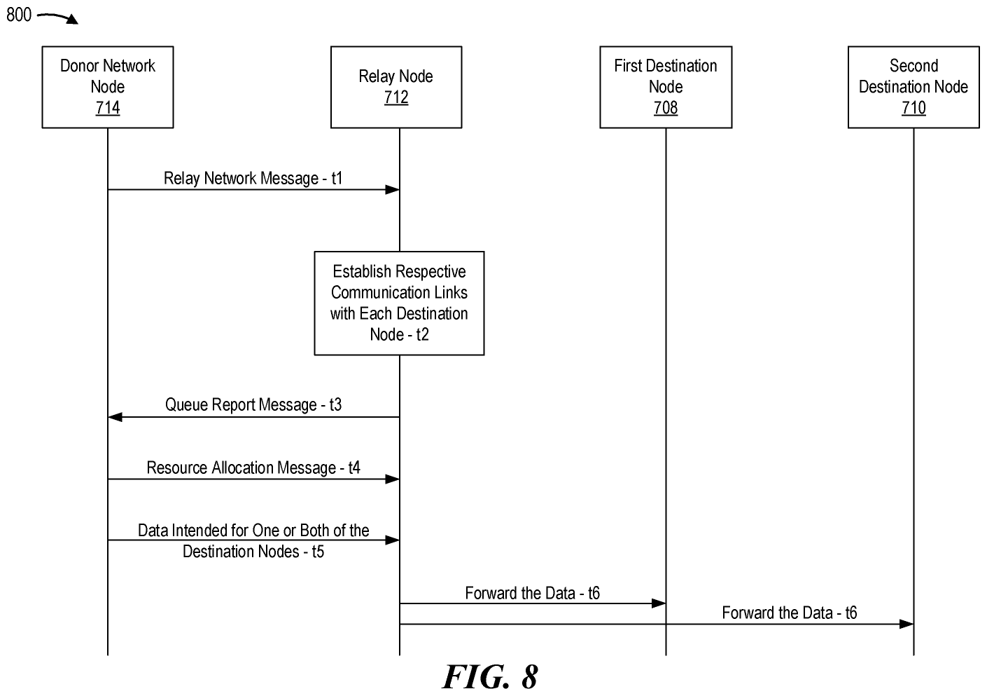

As discussed, a sidelink relay network may be formed to increase network throughput by utilizing a buffer in each relay node. The increased network throughput may enable high-throughput applications, such as video streaming. FIG. 8 is a timing diagram illustrating an example 800 of forming a sidelink relay network, such as the sidelink relay network 700 described with reference to FIG. 7, in accordance with various aspects of the present disclosure. As discussed, the sidelink relay network may include one or more relay nodes (for example, a set of relay nodes) and one or more destination nodes (for example, a set of destination nodes). The destination nodes may also be referred to as destination UEs. For ease of explanation, the example 800 of FIG. 8 only includes one relay node 712 and two destination UEs 708 and 710.

In some examples, at time t1, the relay node 712 receives, from the donor network node 714, a relay network message indicating configuration information associated with the sidelink relay network. The relay network message may be received via a DCI format defined within an existing wireless standard (for example, 3GPP Standard) or a new DCI format. In some examples, the relay node 712 may forward the relay network message to each destination node 708 and 710 via a sidelink channel, such as a PSSCH or PSCCH.

In some examples, a wireless communication network may include multiple relay nodes and multiple destination nodes. Additionally, the donor network node may be associated with multiple sidelink relay networks. In such examples, different subsets of the relay nodes and different subsets of the destination nodes may be associated with one of the sidelink relay networks. Additionally, some relay nodes and some destination nodes may not be associated with a sidelink relay network. Because each donor network node may be associated with one or more sidelink relay networks, the relay network message may configure a particular sidelink relay network. In some examples, the relay network message may indicate one or more of a group of destination node identifiers (IDs), a DCI type ID, a relay access network ID, a scheduling mode associated with the sidelink relay network, scheduling parameters, an interval for transmitting a queue report message, or a number of queue length quantization bits per destination node. The destination node ID may identify destination nodes, such as one or both of the first destination node 708 or the second destination node 710, that are intended to receive packets (for example, information) transmitted via the relay node 712. The DCI type ID may be a unique ID indicating whether the DCI message includes information for forming or updating a sidelink relay network. The relay network ID may distinguish a sidelink relay network associated with the relay network message from other sidelink relay networks associated with the donor network node. Each sidelink relay network may be associated with a unique relay network ID. The scheduling mode may indicate a scheduling policy, such as MMW, MDB, MSB, or PF. The scheduling parameter may indicate scheduling parameters for each relay node in the set of relay nodes associated with the sidelink relay network and each destination node in the set of destination nodes associated with the sidelink relay network. In some examples, the scheduling parameters may indicate one or more scaling factors for each communication link (for example, sidelink communication link) established between a relay node and a destination node. The interval for transmitting the queue report message may be an interval for each relay node and each destination node to share one or more channel characteristics and queueing information.

In some examples, the donor network node 714 may select one or more relay nodes and one or more destination nodes for the sidelink relay network based on one or more conditions. The conditions may be based on one or more of a relay buffer size, a device application type, a device channel coherence time, or a device zone ID. In some examples, the one or more relay conditions may include a relay buffer size of the relay node 712 being greater than a buffer threshold, a respective application type associated with each destination node 708 and 710 satisfying an application type condition, an estimated channel coherence time for a respective sidelink channel between the relay node 712 and each destination node 708 and 710 being within a coherence range, or a respective zone ID associated with each destination node 708 and 710 satisfying a zone ID condition.

The relay buffer size may be based on an available buffer size for each relay node, such as the relay node 712. A relay buffer size condition may be satisfied based on the relay buffer size being greater than or equal to a relay buffer size threshold. A relay node, such as the relay node 712 that received the relay network message at time t1, may not serve in the sidelink relay network if an associated relay buffer size is less than the relay buffer size threshold. In some examples, a channel coherence time may be estimated by each destination node 708 and 710 and the relay node 712. A channel coherence time condition may be satisfied based on the estimated channel coherence time being within a preconfigured range. Multi-hop diversity or spatial diversity may be utilized by one or more of the destination nodes 708 or 710 based on the respective estimated channel coherence time being within the preconfigured range. The relay node 712 may not serve one or more of the destination nodes 708 or 710 if the respective estimated channel coherence time is not within the preconfigured range. In some cases, the first destination node 708 and the second destination node 710 may be associated with a respective zone ID. In such examples, the respective zone ID of one or both of the first destination node 708 or the second destination node 710 may be associated with a zone (for example, area) that may not be permitted to join the sidelink relay network. In some such examples, one or both of the first destination node 708 or the second destination node 710 may not join the sidelink relay network if the respective zone ID is associated with a forbidden zone or a non-allowed zone. Zones that are not allowed or forbidden may be defined within a wireless standard, such as 3GPP Release 17. In some examples, the first destination node 708 or the second destination node 710 may be associated with a respective application type. In such examples, the respective application type of one or both of the first destination node 708 or the second destination node 710 may be associated with an application type that may not be permitted to join the sidelink relay network. In some such examples, low latency or low throughput applications may not be suitable for the sidelink relay network because such applications may increase network delay. In some examples, a packet delay budget (PDB) of application packets may be specified for the application types that may be allowed to join the sidelink relay network.

In some examples, the donor network node 714 may determine the application type of the first destination node 708 and the second destination node 710 based on application type information received from one or both of the relay node 712 or each destination node 708 and 710. Additionally, the donor network node 714 may transmit a request, to one or both of the relay node 712 or each destination node 708 and 710, for one or more of the relay buffer size, the estimated channel coherence time, or the device zone ID. Each destination node 708 and 710 may transmit the requested information to the relay node 712 via sidelink control information (SCI), a MAC CE, a MAC header, or a PSSCH. The relay node 712 may forward the requested information, to the donor network node 714, using an existing or new buffer status report (BSR) format. The relay node 712 and each destination node 708 and 710 may report the requested information via one or more BSRs. Each BSR may indicate one or more of the relay buffer size, the estimate channel coherence time, or the device zone ID, as requested by the donor network node 714.

The relay network message of time t1 is not limited to an initial network configuration. In some examples, the relay network message may remove or add one or both of: one or more relay nodes or one or more destination nodes to an established sidelink relay network. In such examples, one or more bits may indicate whether the relay network message is an initial configuration message or an add or remove message. Additionally, one or more bits may indicate an ID of each device (for example, relay node or destination node) that is to be added or removed from the sidelink relay network. For ease of explanation, in the example of FIG. 8, the relay network message is an initial message used to establish the sidelink relay network.

Based on receiving the configuration information at time t1, the relay node 712 may establish a communication link with one or more of the destination nodes 708 and 710 (time t2). In some examples, each communication link may include one or more sidelink channels. After establishing the communication links, the relay node 712 may forward packets (not shown in the example of FIG. 8) received from the donor network node to one or both of the destination nodes 708 and 710. Additionally, the relay node 712 may forward packets (not shown in the example of FIG. 8) received from one or both of the destination nodes 708 and 710 to the donor network node 714.

During operation of the sidelink relay network, at time t3, the relay node 712 may transmit a queue report message indicating one or more channel characteristics and queue information to one or both of the donor network node 714 or other relay nodes in the sidelink relay network. The recipient (for example, one or both of the donor network node 714 or other relay nodes in the sidelink relay network) of the queue report message may be based on the scheduling policy associated with the sidelink relay network. The one or more channel characteristics (for example, channel conditions) may be reported or shared using existing channel characteristic reporting techniques. Additionally, the queue information may be reported via a new BSR format. In contrast to conventional BSR formats, in which an entire buffer size is reported to a network node, the relay node 712 may report a queue size for each destination node 708 and 710. In some examples, the new BSR format associates a destination node ID with each queue size. In some other examples, for some scheduling policies, such as PF, the relay nodes may share the queue information with each other via the PSSCH or PSCCH. In such examples, the queue information may indicate a queue size for each destination node, and each queue size may be associated with a destination ID.

As shown in FIG. 8, at time t4, the relay node 712 may receive a resource allocation message indicating a group of resources, based on the channel characteristics and queue information indicated in the queue report message. The group of resources may be allocated among the set of relay nodes, to be used by the relay nodes for communicating with the set of destination nodes via respective sidelink communication links. In some examples, when the sidelink relay network includes two or more relay nodes, the relay nodes allocate the group of resources among a subset of the set of relay nodes or the entire set of relay nodes. In some examples, a link selection message may be merged with the resource allocation message. In other examples, the donor network node 714 separately transmits the link selection message and the resource allocation message. For some scheduling policies, such as MMW, MDB, and MSB, the donor network node 714 may allocate the group of resources among the set of relay nodes based on an order of transmissions from the set of relay nodes. The order of transmissions may be determined, at the donor network node 714, based on one or more of the one or more channel characteristics, respective queue information of each relay node in the set of relay nodes, queue information of the donor network node 714, or previous transmission history of the set of relay nodes. In the example of FIG. 8, the donor network node 714 may allocate the group of resources to the relay node 712 based on an order of transmissions to each of the destination nodes 708 and 710. In some other scheduling policies, such as PF, the group of resources may include resources for multiple slots. The set of relay nodes may coordinate with each other to allocate the group of resources based on a respective priority of each relay node in the set of relay nodes. In the example of FIG. 8, the relay node 712 may allocate the group of resources based on a priority of transmissions to each of the destination nodes 708 and 710. In other scheduling policies, such as PF in an unlicensed mode, the set of relay nodes may coordinate with each other to allocate the group of resources based on slots reserved by each relay node of the set of relay nodes. The slots may be reserved based on channel occupancy time (COT) sharing among the set of relay nodes. In such scheduling policies, one bit may be included in a header, such as a SCI header (for example, SCI-1 or SCI-2), a MAC header, or a MAC control element (MAC-CE) MAC-CE header, to indicate that the reserved slots are for the sidelink relay network. Additionally, the sidelink relay network ID may be included in the header. In the example of FIG. 8, the relay node 712 may allocate the group of resources based on slots reserved for transmissions to each of the destination nodes 708 and 710.

As shown in FIG. 8, at time t5, the relay node 712 may receive data from the donor network node 714. The data may be intended for one or both of the destination nodes 708 and 710. At time t6, the relay node 712 may forward, to one or both of the destination nodes 708 and 710 via one or more respective sidelink channels, the received data via one or more resources of the group of resources.

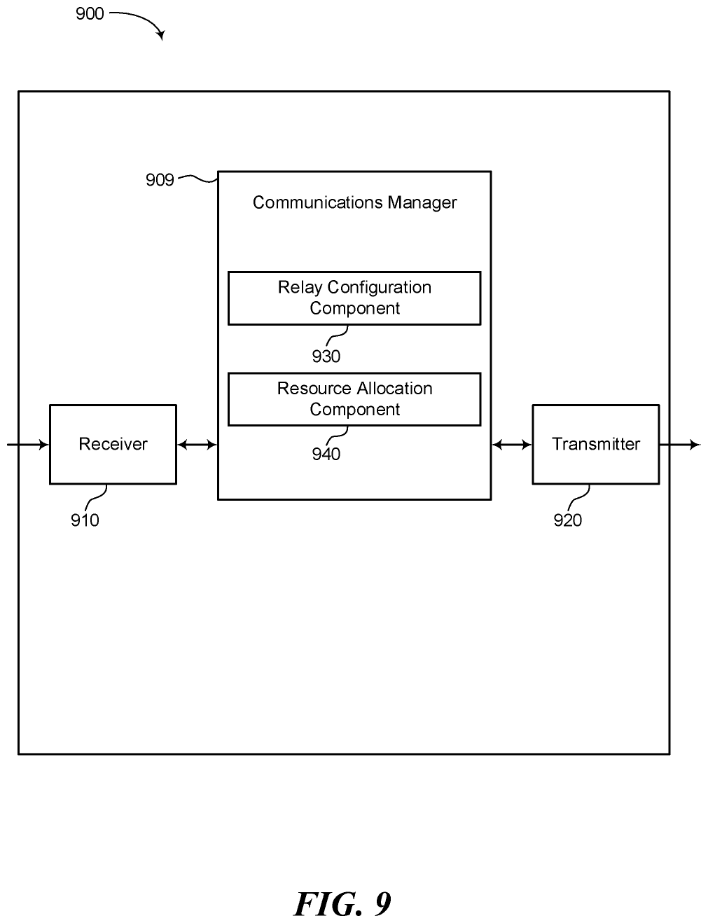

FIG. 9 is a block diagram illustrating an example wireless communication device that supports configuring a sidelink relay network, in accordance with some aspects of the present disclosure. The device 900 may be an example of aspects of a relay node 712 described with reference to FIGS. 7 and 8. The wireless communications device 900 may include a receiver 910, a communications manager 909, a transmitter 920, a relay configuration component 930, and a resource allocation component 940, which may be in communication with one another (for example, via one or more buses). In some examples, the wireless communications device 900 is configured to perform operations, including operations of the process 1000 described below with reference to FIG. 10.

In some examples, the wireless communications device 900 can include a chip, chipset, package, or device that includes at least one processor and at least one modem (for example, a 5G modem or other cellular modem). In some examples, the communications manager 909, or its sub-components, may be separate and distinct components. In some examples, at least some components of the communications manager 909 are implemented at least in part as software stored in a memory. For example, portions of one or more of the components of the communications manager 909 can be implemented as non-transitory code executable by the processor to perform the functions or operations of the respective component.

The receiver 910 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communications devices via various channels including control channels (for example, a physical downlink control channel (PDCCH), physical uplink control channel (PUCCH), or physical sidelink control channel PSCCH) and data channels (for example, a physical downlink shared channel (PDSCH), physical sidelink shared channel (PSSCH), a physical uplink shared channel (PUSCH)). The other wireless communications devices may include, but are not limited to, a donor network node 714 described with reference to FIGS. 7 and 8.

The received information may be passed on to other components of the device 900. The receiver 910 may be an example of aspects of the receive processor 256 described with reference to FIG. 2. The receiver 910 may include a set of radio frequency (RF) chains that are coupled with or otherwise utilize a set of antennas (for example, the set of antennas may be an example of aspects of the antennas 252 described with reference to FIG. 2).

The transmitter 920 may transmit signals generated by the communications manager 909 or other components of the wireless communications device 900. In some examples, the transmitter 920 may be collocated with the receiver 910 in a transceiver. The transmitter 920 may be an example of aspects of the transmit processor 268 described with reference to FIG. 2. The transmitter 920 may be coupled with or otherwise utilize a set of antennas (for example, the set of antennas may be an example of aspects of the antennas 252 described with reference to FIG. 2), which may be antenna elements shared with the receiver 910. In some examples, the transmitter 920 is configured to transmit control information in a PUCCH, PSCCH, or PDCCH and data in a physical uplink shared channel (PUSCH), PSSCH, or PDSCH.

The communications manager 909 may be an example of aspects of the controller/processor 259 described with reference to FIG. 2. The communications manager 909 may include the relay configuration component 930 and the resource allocation component 940. In some examples, working in conjunctions with the receiver 910, the relay configuration component 930 receives, from a donor network node, a relay network message indicating configuration information associated with a sidelink relay network. The sidelink relay network may include a set of relay nodes and a set of destination nodes. The set of relay nodes may include the first relay node. The relay network message may be received at a group of relay nodes. The set of relay nodes may be a subset of relay nodes from the group of relay nodes. Working in conjunction with the transmitter 920, the relay configuration component 930 transmits, to one or both of the donor network node or one or more other relay nodes in the set of relay nodes, a queue report message indicating one or more channel characteristics and queue information. Furthermore, working in conjunction with the receiver 910, the resource allocation component 940 receives, from the donor network node, a resource allocation message indicating a group of resources, based at least in part on the queue report message, for communicating with the set of destination nodes. Additionally, working in conjunction with one or both of the resource allocation component 940 and the transmitter 920, the communications manager 909 transmits, to one or more destination nodes in the set of destination nodes via one or more respective sidelink channels, data via one or more resources of the group of resources.

FIG. 10 is a flow diagram illustrating an example process 1000 performed by a relay node, in accordance with some aspects of the present disclosure. The relay node may be an example of a relay node 712 described with reference to FIGS. 7 and 8. The example process 1000 is an example of configuring a sidelink relay network. As shown in FIG. 10, the process 1000 begins at block 1002 by receiving, from a donor network node, a relay network message indicating configuration information associated with a sidelink relay network. The sidelink relay network may include a set of relay nodes and a set of destination nodes. The set of relay nodes may include the first relay node. In some examples, the relay node may transmit the configuration information to the one or more destination nodes in the set of destination nodes via the one or more respective sidelink channels. In some examples, the relay network message may be received based on one or more of: a respective relay buffer size of each relay node in the set of relay nodes being greater than a buffer threshold, a respective application type associated with each destination node in the set of destination nodes satisfying an application type condition, a respective estimated channel coherence time associated with each destination node in the set of destination nodes satisfying a channel coherence condition, or a respective zone ID associated with each destination node in the set of destination nodes satisfying a zone ID condition. Based on receiving the relay network message, the relay node may establish a sidelink communication link with each destination node in the set of destination nodes via the one or more respective sidelink channels. Additionally, or alternatively, based on receiving the relay network message, the relay node may add one or both one or both of a second relay node to the set of relay nodes or a destination node to the set of destination nodes. Additionally, or alternatively, based on receiving the relay network message, the relay node may subtract one or both one or both of a second relay node from the set of relay nodes or a destination node from the set of destination nodes

At block 1004, the process 1000 transmits, to one or both of the donor network node or one or more other relay nodes in the set of relay nodes, a queue report message indicating one or more channel characteristics and queue information. The queue report message may transmitted to the network node, on an uplink channel, via a BSR. Additionally, or alternatively, the queue report message is transmitted to other relay nodes in the set of relay nodes via the one or more respective sidelink channels. At block 1006, the process 1000 receives, from the donor network node, a resource allocation message indicating a group of resources, based at least in part on the queue report message, for communicating with the set of destination nodes. At block 1008, the process 1000 transmits, to one or more destination nodes in the set of destination nodes via one or more respective sidelink channels, data via one or more resources of the group of resources.

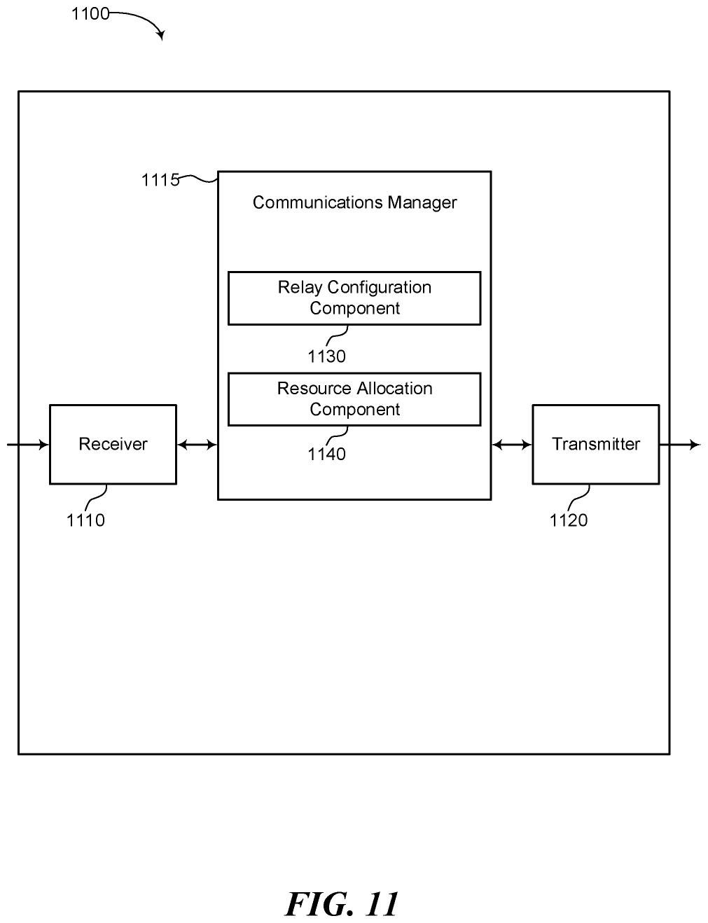

FIG. 11 is a block diagram illustrating an example wireless communication device 1100 that supports configuring a sidelink relay network, in accordance with aspects of the present disclosure. The wireless communication device 1100 may be an example of a donor network node 714 described with reference to FIGS. 7 and 8. The wireless communication device 1100 may include a receiver 1110, a communications manager 1115, a relay configuration component 1130, a resource allocation component 1140, and a transmitter 1120, which may be in communication with one another (for example, via one or more buses). In some examples, the wireless communication device 1100 is configured to perform operations, including operations of the process 1200 described below with reference to FIG. 12.

In some examples, the wireless communication device 1100 can include a chip, system on chip (SOC), chipset, package, or device that includes at least one processor and at least one modem (for example, a 5G modem or other cellular modem). In some examples, the communications manager 1115, or its sub-components, may be separate and distinct components. In some examples, at least some components of the communications manager 1115 are implemented at least in part as software stored in a memory. For example, portions of one or more of the components of the communications manager 1115 can be implemented as non-transitory code executable by the processor to perform the functions or operations of the respective component.

The receiver 1110 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, a UE 104, described with reference to FIGS. 1, 3, and 5.

The received information may be passed on to other components of the wireless communication device 1100. The receiver 1110 may be an example of aspects of the receive processor 270 described with reference to FIG. 2. The receiver 1110 may include a set of radio frequency (RF) chains that are coupled with or otherwise utilize a set of antennas (for example, the set of antennas may be an example of aspects of the antennas 234 described with reference to FIG. 2).

The transmitter 1120 may transmit signals generated by the communications manager 1115 or other components of the wireless communication device 1100. In some examples, the transmitter 1120 may be collocated with the receiver 1110 in a transceiver. The transmitter 1120 may be an example of aspects of the transmit processor 216 described with reference to FIG. 2. The transmitter 1120 may be coupled with or otherwise utilize a set of antennas (for example, the set of antennas may be an example of aspects of the antennas 252), which may be antenna elements shared with the receiver 1110. In some examples, the transmitter 1120 is configured to transmit control information in a PDCCH or a PSCCH and data in a PDSCH or PSSCH.

The communications manager 1115 may be an example of aspects of the controller/processor 275 described with reference to FIG. 2. The communications manager 1115 includes the relay configuration component 1130 and the resource allocation component 1140. In some examples, working in conjunction with the transmitter 1120, the relay configuration component 1130 transmits, to a group of relay nodes, a relay network message indicating configuration information associated with a sidelink relay network. The sidelink relay network including a set of relay nodes of the group of relay nodes and a set of destination nodes. Working in conjunction with the receiver 1110, the resource allocation component 1140 receives, from each relay node of the one or more relay nodes, a respective queue report message indicating one or more channel characteristics and queue information. Furthermore, working in conjunction with the transmitter 1120, the resource allocation component 1140 transmits, based on receiving the queue report messages from the set of relay nodes, a resource allocation message to the set of relay nodes that indicates a group of resources allocated among the set of relay nodes for communicating with the set of destination nodes via respective sidelink channels.

FIG. 12 is a flow diagram illustrating an example of a process 1200 performed by a wireless device, in accordance with some aspects of the present disclosure. The wireless device may be an example of a donor network node 714 described with reference to FIGS. 7 and 8. The example process 1200 is an example of configuring a sidelink relay network. As shown in FIG. 12, the process 1200 begins at block 1202 by transmitting, to a group of relay nodes, a relay network message indicating configuration information associated with a sidelink relay network. The sidelink relay network may include a set of relay nodes of the group of relay nodes and a set of destination nodes. At block 1204, the process 1200 receives, from each relay node of the one or more relay nodes, a respective queue report message indicating one or more channel characteristics and queue information. At block 1206, the process 1200 transmits, based on receiving the queue report messages from the set of relay nodes, a resource allocation message to the set of relay nodes that indicates a group of resources allocated among the set of relay nodes for communicating with the set of destination nodes via respective sidelink channels.

Implementation examples are described in the following numbered clauses:
Clause 1. A method for wireless communication performed by a first relay node, comprising: receiving, from a donor network node, a relay network message indicating configuration information associated with a sidelink relay network, the sidelink relay network including a set of relay nodes and a set of destination nodes, the set of relay nodes including the first relay node; transmitting, to one or both of the donor network node or one or more other relay nodes in the set of relay nodes, a queue report message indicating one or more channel characteristics and queue information; receiving, from the donor network node, a resource allocation message indicating a group of resources, based at least in part on the queue report message, for communicating with the set of destination nodes; and transmitting, to one or more destination nodes in the set of destination nodes via one or more respective sidelink channels, data via one or more resources of the group of resources.
Clause 2. The method of Clause 1, wherein the configuration information indicates one or more of: a group of destination node IDs, a DCI type ID, a sidelink relay network ID, a scheduling mode associated with the sidelink relay network, an interval for transmitting the queue report message, or a number of queue length quantization bits per destination node.
Clause 3. The method of any one of Clauses 1-2, further comprising transmitting the configuration information to the one or more destination nodes in the set of destination nodes via the one or more respective sidelink channels.
Clause 4. The method of any one of Clauses 1-3, wherein the relay network includes the set of relay nodes and the set of destination nodes based on one or more of: a respective relay buffer size of each relay node in the set of relay nodes being greater than a buffer threshold, a respective application type associated with each destination node in the set of destination nodes satisfying an application type condition, a respective estimated channel coherence time associated with each destination node in the set of destination nodes satisfying a channel coherence condition, or a respective zone ID associated with each destination node in the set of destination nodes satisfying a zone ID condition.
Clause 5. The method of any one of Clauses 1-4, further comprising establishing, based on receiving the configuration information, a sidelink communication link with each destination node in the set of destination nodes via the one or more respective sidelink channels.
Clause 6. The method of any one of Clauses 1-5, further comprising adding, based on receiving the configuration information, one or both of a second relay node to the set of relay nodes or a destination node to the set of destination nodes.
Clause 7. The method of any one of Clauses 1-5, further comprising removing, based on receiving the configuration information, one or both of a second relay node from the set of relay nodes or a destination node from the set of destination nodes.
Clause 8. The method of any one of Clauses 1-7, wherein: the queue report message is transmitted to the network node, on an uplink channel, via a BSR; and the queue information indicates a group of relay buffer sizes at the first relay node, each relay buffer size of the group of relay buffer sizes is associated with a respective destination node in the set of destination nodes.
Clause 9. The method of any one of Clauses 1-8, wherein: the queue report message is transmitted to other relay nodes in the set of relay nodes via the one or more respective sidelink channels; the queue information indicates a group of relay buffer sizes at the first relay node; and each relay buffer size of the group of relay buffer sizes is associated with a respective destination node in the set of destination nodes.
Clause 10. The method of any one of Clauses 1-9, wherein: the donor network node allocates the group of resources among the set of relay nodes based on an order of transmissions from the set of relay nodes; and the order of transmissions is determined, at the network node, based on one or more of the one or more channel characteristics, respective queue information of each relay node in the set of relay nodes, queue information of the donor network node, or previous transmission history of the set of relay nodes.
Clause 11. The method of any one of Clauses 1-9, further comprising coordinating with other nodes in the set of relay nodes to allocate the group of resources based on a respective priority of each relay node in the set of relay nodes.
Clause 12. The method of any one of Clauses 1-9, further comprising: reserving one or more slots based on COT sharing; and coordinating with other nodes in the set of relay nodes to allocate the group of resources based on one or more respective slots reserved by each relay node in the set of relay nodes.
Clause 13. A method for wireless communication performed by a donor network node, comprising: transmitting, to a group of relay nodes, a relay network message indicating configuration information associated with a sidelink relay network, the sidelink relay network including a set of relay nodes of the group of relay nodes and a set of destination nodes; receiving, from each relay node of the set of relay nodes, a respective queue report message indicating one or more channel characteristics and queue information; and transmitting, based on receiving the queue report messages from the set of relay nodes, a resource allocation message to the set of relay nodes that indicates a group of resources allocated among the set of relay nodes for communicating with the set of destination nodes via respective sidelink channels.
Clause 14. The method of Clause 13, wherein the configuration information indicates one or more of a group of destination node IDs, a DCI type ID, a sidelink relay network ID, a scheduling mode associated with the sidelink relay network, an interval for transmitting the queue report message, or a number of queue length quantization bits per destination node.
Clause 15. The method of any one of Clauses 13-14, further comprising receiving, from each relay node in the set of relay nodes, a respective relay buffer message indicating a relay buffer size, wherein the sidelink relay network includes the one or more relay nodes and the one or more destination nodes based on one or more of: the respective relay buffer size of each relay node of the one or more relay nodes being greater than a buffer threshold, a respective application type associated with each destination node of the one or more destination nodes satisfying an application type condition, a respective estimated channel coherence time for each destination node of the one or more destination nodes satisfying a channel coherence condition, or a respective zone ID associated with each destination node of the one or more destination nodes satisfying a zone ID condition.
Clause 16. The method of any one of Clauses 13-15, wherein: the respective queue report message is received via a BSR; the respective queue report message indicates a group of relay buffer sizes; and each relay buffer size of the group of relay buffer sizes is associated with a respective destination node of the one or more destination nodes.
Clause 17. The method of any one of Clauses 13-16, further comprising determining an order of transmissions from the set of relay nodes to the set of destination nodes based on one or more of: the one or more channel characteristics, respective queue information associated with each relay node in the set of relay nodes, queue information of the donor network node, or previous transmission history of the set of relay nodes, wherein the resource allocation message further indicates an allocation of the group of resources among the set of relay nodes based on the order of transmissions.
Clause 18. The method of any one of Clauses 13-17, wherein the set of relay nodes establish respective sidelink communication links with the set of destination nodes based on the configuration information.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one”or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication performed by a first relay node, comprising:
receiving, from a donor network node, a relay network message indicating configuration information associated with a sidelink relay network, the sidelink relay network including a set of relay nodes and a set of destination nodes, the set of relay nodes including the first relay node;
transmitting, to one or both of the donor network node or one or more other relay nodes in the set of relay nodes, a queue report message indicating one or more channel characteristics and queue information;
receiving, from the donor network node, a resource allocation message indicating a group of resources, based at least in part on the queue report message, for communicating with the set of destination nodes; and
transmitting, to one or more destination nodes in the set of destination nodes via one or more respective sidelink channels, data via one or more resources of the group of resources.

2. The method of claim 1, wherein the configuration information indicates one or more of: a group of destination node identifiers (IDs), a downlink control information (DCI) type ID, a sidelink relay network ID, a scheduling mode associated with the sidelink relay network, an interval for transmitting the queue report message, or a number of queue length quantization bits per destination node.

3. The method of claim 1, further comprising transmitting the configuration information to the one or more destination nodes in the set of destination nodes via the one or more respective sidelink channels.

4. The method of claim 1, wherein the relay network includes the set of relay nodes and the set of destination nodes based on one or more of: a respective relay buffer size of each relay node in the set of relay nodes being greater than a buffer threshold, a respective application type associated with each destination node in the set of destination nodes satisfying an application type condition, a respective estimated channel coherence time associated with each destination node in the set of destination nodes satisfying a channel coherence condition, or a respective zone ID associated with each destination node in the set of destination nodes satisfying a zone ID condition.

5. The method of claim 1, further comprising establishing, based on the configuration information, a sidelink communication link with the one or more destination node via the one or more respective sidelink channels.

6. The method of claim 1, further comprising adding, based on receiving the relay network message, one or both of a second relay node to the set of relay nodes or a destination node to the set of destination nodes.

7. The method of claim 1, further comprising removing, based on receiving the relay network message, one or both of a second relay node from the set of relay nodes or a destination node from the set of destination nodes.

8. The method of claim 1, wherein:
the queue report message is transmitted to the network node, on an uplink channel, via a buffer status report (BSR); and
the queue information indicates a group of relay buffer sizes at the first relay node, each relay buffer size of the group of relay buffer sizes is associated with a respective destination node in the set of destination nodes.

9. The method of claim 1, wherein:
the queue report message is transmitted to other relay nodes in the set of relay nodes via the one or more respective sidelink channels;
the queue information indicates a group of relay buffer sizes at the first relay node; and
each relay buffer size of the group of relay buffer sizes is associated with a respective destination node in the set of destination nodes.

10. The method of claim 1, wherein:
the donor network node allocates the group of resources among the set of relay nodes based on an order of transmissions from the set of relay nodes; and
the order of transmissions is determined, at the network node, based on one or more of the one or more channel characteristics, respective queue information of each relay node in the set of relay nodes, queue information of the donor network node, or previous transmission history of the set of relay nodes.

11. The method of claim 1, further comprising coordinating with other relay nodes in the set of relay nodes to allocate the group of resources based on a respective priority of each relay node in the set of relay nodes.

12. The method of claim 1, further comprising:
reserving one or more slots based on channel occupancy time (COT) sharing; and
coordinating with other relay nodes in the set of relay nodes to allocate the group of resources based on one or more respective slots reserved by each relay node in the set of relay nodes.

13. An apparatus for wireless communications at a first relay node, comprising:
a processor; and
a memory coupled with the processor and storing instructions operable, when executed by the processor, to cause the apparatus to:
receive, from a donor network node, a relay network message indicating configuration information associated with a sidelink relay network, the sidelink relay network including a set of relay nodes and a set of destination nodes, the set of relay nodes including the first relay node;
transmit, to one or both of the donor network node or one or more other relay nodes in the set of relay nodes, a queue report message indicating one or more channel characteristics and queue information;
receive, from the donor network node, a resource allocation message indicating a group of resources, based at least in part on the queue report message, for communicating with the set of destination nodes; and
transmit, to one or more destination nodes in the set of destination nodes via one or more respective sidelink channels, data via one or more resources of the group of resources.

14. The apparatus of claim 13, wherein the configuration information indicates one or more of: a group of destination node identifiers (IDs), a downlink control information (DCI) type ID, a sidelink relay network ID, a scheduling mode associated with the sidelink relay network, an interval for transmitting the queue report message, or a number of queue length quantization bits per destination node.

15. The apparatus of claim 13, wherein execution of the instructions further cause the apparatus to transmit the configuration information to the one or more destination nodes in the set of destination nodes via the one or more respective sidelink channels.

16. The apparatus of claim 13, wherein the relay network includes the set of relay nodes and the set of destination nodes based on one or more of: a respective relay buffer size of each relay node in the set of relay nodes being greater than a buffer threshold, a respective application type associated with each destination node in the set of destination nodes satisfying an application type condition, a respective estimated channel coherence time associated with each destination node in the set of destination nodes satisfying a channel coherence condition, or a respective zone ID associated with each destination node in the set of destination nodes satisfying a zone ID condition.

17. The apparatus of claim 13, wherein execution of the instructions further cause the apparatus to establish, based on the configuration information, a sidelink communication link with the one or more destination node via the one or more respective sidelink channels.

18. The apparatus of claim 13, wherein:
the queue report message is transmitted to the network node, on an uplink channel, via a buffer status report (BSR); and
the queue information indicates a group of relay buffer sizes at the first relay node, each relay buffer size of the group of relay buffer sizes is associated with a respective destination node in the set of destination nodes.

19. A method for wireless communication performed by a donor network node, comprising:
transmitting, to a group of relay nodes, a relay network message indicating configuration information associated with a sidelink relay network, the sidelink relay network including a set of relay nodes of the group of relay nodes and a set of destination nodes;
receiving, from each relay node in the set of relay nodes, a respective queue report message indicating one or more channel characteristics and queue information; and
transmitting, based on receiving the queue report messages from the set of relay nodes, a resource allocation message to the set of relay nodes that indicates a group of resources allocated among the set of relay nodes for communicating with the set of destination nodes via respective sidelink channels.

20. The method of claim 19, wherein the configuration information indicates one or more of a group of destination node identifiers (IDs), a downlink control information (DCI) type ID, a sidelink relay network ID, a scheduling mode associated with the sidelink relay network, an interval for transmitting the queue report message, or a number of queue length quantization bits per destination node.

21. The method of claim 19, further comprising receiving, from each relay node in the set of relay nodes, a respective relay buffer message indicating a relay buffer size,
wherein the sidelink relay network includes the set of relay nodes and the set of destination nodes based on one or more of: the respective relay buffer size of each relay node of the set of relay nodes being greater than a buffer threshold, a respective application type associated with each destination node of the set of destination nodes satisfying an application type condition, a respective estimated channel coherence time for each destination node of the set of destination nodes satisfying a channel coherence condition, or a respective zone ID associated with each destination node of the set of destination nodes satisfying a zone ID condition.

22. The method of claim 19, wherein:
the respective queue report message is received via a buffer status report (BSR);
the respective queue report message indicates a group of relay buffer sizes; and
each relay buffer size of the group of relay buffer sizes is associated with a respective destination node of the set of destination nodes.

23. The method of claim 19, further comprising determining an order of transmissions from the set of relay nodes to the set of destination nodes based on one or more of: the one or more channel characteristics, respective queue information associated with each relay node in the set of relay nodes, queue information of the donor network node, or previous transmission history of the set of relay nodes,
wherein the resource allocation message further indicates an allocation of the group of resources among the set of relay nodes based on the order of transmissions.

24. The method of claim 19, wherein each relay node in the set of relay node establishes a respective sidelink communication link with each of one or more destination nodes the set of destination nodes based on the configuration information.

25. An apparatus for wireless communications at a donor network node, comprising:
a processor; and
a memory coupled with the processor and storing instructions operable, when executed by the processor, to cause the apparatus to:
transmit, to a group of relay nodes, a relay network message indicating configuration information associated with a sidelink relay network, the sidelink relay network including a set of relay nodes of the group of relay nodes and a set of destination nodes;
receive, from each relay node of the set of relay nodes, a respective queue report message indicating one or more channel characteristics and queue information; and
transmit, based on receiving the queue report messages from the set of relay nodes, a resource allocation message to the set of relay nodes that indicates a group of resources allocated among the set of relay nodes for communicating with the set of destination nodes via respective sidelink channels.

26. The apparatus of claim 25, wherein the configuration information indicates one or more of a group of destination node identifiers (IDs), a downlink control information (DCI) type ID, a sidelink relay network ID, a scheduling mode associated with the sidelink relay network, an interval for transmitting the queue report message, or a number of queue length quantization bits per destination node.

27. The apparatus of claim 25, wherein execution of the instructions further cause the apparatus to receive, from each relay node in the set of relay nodes, a respective relay buffer message indicating a relay buffer size,
wherein the sidelink relay network includes the set of relay nodes and the set of destination nodes based on one or more of: the respective relay buffer size of each relay node of the set of relay nodes being greater than a buffer threshold, a respective application type associated with each destination node of the set of destination nodes satisfying an application type condition, a respective estimated channel coherence time for each destination node of the set of destination nodes satisfying a channel coherence condition, or a respective zone ID associated with each destination node of the set of destination nodes satisfying a zone ID condition.

28. The apparatus of claim 25, wherein:
the respective queue report message is received via a buffer status report (BSR);
the respective queue report message indicates a group of relay buffer sizes; and
each relay buffer size of the group of relay buffer sizes is associated with a respective destination node of the set of destination nodes.

29. The apparatus of claim 25, wherein execution of the instructions further cause the apparatus to determine an order of transmissions from the set of relay nodes to the set of destination nodes based on one or more of: the one or more channel characteristics, respective queue information associated with each relay node in the set of relay nodes, queue information of the donor network node, or previous transmission history of the set of relay nodes,
wherein the resource allocation message further indicates an allocation of the group of resources among the set of relay nodes based on the order of transmissions.

30. The apparatus of claim 25, wherein each relay node in the set of relay node establishes a respective sidelink communication link with each of one or more destination nodes in the set of destination nodes based on the configuration information.
